(19) United States
(12) Patent Application Publication
(10) Pub. No.: US 2018/0308109 A1
(43) Pub. Date: Oct. 25, 2018

(54) METHODS AND SYSTEMS FOR BUILDING INTIMACY

(71) Applicant: Franklin Innovations, LLC, Mendota Heights, MN (US)

(72) Inventor: Thomas Kurvers, Mendota Heights, MN (US)

(21) Appl. No.: 15/767,921

(22) PCT Filed: Oct. 12, 2016
(86) PCT No.: PCT/US16/56520

§ 371 Date: Apr. 12, 2018

Related U.S. Application Data
(60) Provisional application No. 62/241,921, filed on Oct. 15, 2015.

(51) Int. Cl. G06Q 30/02; G06Q 30/06

(52) U.S. Cl. CPC G06Q 30/0201; G06F 17/3064; G06Q 30/0631

(57) ABSTRACT

Systems and methods are used for receiving users interest level in a plurality of products, such as intimate or sexual products. Pairs of users can individually provide ratings representative of each users interest level in each of a variety of products. A list of recommended products can be generated and provided to the pair of users based on the individual ratings. The list can include products for which each user expressed a minimum level of interest. Pairs of users can the comfortably shop for products that each user knows the other is interested in. Lists can include product names, details, links to websites from which a product can be purchased, and the like. Interest level information from a plurality of users can be aggregated and categorized to provide access to information regarding an overall interest level in a variety of products.

### RELATED APPLICATIONS

This application claims the benefit of U.S. Provisional Application No. 62/241,921, filed Oct. 15, 2015, the contents of which are hereby incorporated by reference.

### BACKGROUND OF THE INVENTION

Couples involved in intimate relationships may find it difficult to discuss certain issues related to their relationship, such as sexual preferences or desires. The individuals may find it overly embarrassing to discuss these things aloud and therefore may avoid discussing them all together, or may only discuss them in vague terms. Even couples who are able to discuss sexual issues may only address certain issues and may avoid some more sensitive issues out of embarrassment or fear of their partner's reaction or possible rejection of an idea. These feelings can hinder the relationship and prevent the couple from exploring new areas of intimacy.

In addition to embarrassment surrounding discussing sexual topics, some individuals may lack knowledge about such topics. They may find it difficult to seek information about such topics. For example, it may be embarrassing to seek out books from a bookstore or library, or they may not know where to look for advice or ideas.

In addition, for some couples, such as couples who have been together for many years, the sexual activities in which they engage may become somewhat redundant. For these couples, a source of information and ideas about alternative sexual activities in which they would both be interested could provide renewed excitement to the relationship.

### SUMMARY OF THE INVENTION

Embodiments of the invention provide computer software based methods and systems for enhancing the intimacy of a couple involved in a sexual relationship. The couple answers questions, provided from a database of questions, about their level of interest in engaging in a specific activity, such as a sexual activity. The interest level of each partner is compared for each question. When the both members of the couple express a particular level of interest in the activity, that activity is then provided to the couple in a set of suggested activities selected from a database of intimacy building suggestions. A central processing unit includes software which performs the steps of selecting questions from the database of questions, receiving answers to the questions, comparing the answers, and selecting suggestions from the suggestion database.

### BRIEF DESCRIPTION OF THE DRAWINGS

FIG. 1 is a home page according to embodiments of the invention;

FIG. 2 is a flow chart demonstrating an embodiment of the invention;

FIG. 3 is a flow chart demonstrating another embodiment of the invention;

FIG. 4 is a flow chart demonstrating another embodiment of the invention; and

FIG. 5 is a flow chart demonstrating another embodiment of the invention.

### DETAILED DESCRIPTION

The following detailed description should be read with reference to the drawings, in which like elements in different drawings are numbered identically. The drawings depict exemplary embodiments and are not intended to limit the scope of the invention.

The present invention provides a system and method to facilitate communication between couples regarding sexual topics by allowing couples to express their sexual interests anonymously, comparing the results, and making suggestions. Through use of a software based system, the invention allows couples to express their desires without embarrassment or fear of rejection. The invention provides couples with suggested activities about which both members of the couple have separately expressed interest.

Embodiments of the invention are provided using the world wide web as an internet based service, personal computer, or portable handheld device such as a smartphone or a personal digital assistant (PDA). Each user can interact with the system through a standard HTML interface using his or her web browser or downloaded software saved to hard drive of personal computer or portable handheld device. User and product data may be stored on a secure web server and execution of the product occurs on the web server, with resulting web pages displayed on each user's web browser or stored on hard drive of personal computer or portable handheld device.

The invention includes the software necessary to serve the web pages and to process user responses. The web server is connected to a database system, such as an SQL-based database. Product and user data is stored in the database, which interfaces with the web server using a web-based programming language such as PHP. The invention also include the software necessary to be saved and distributed to personal computers or portable handheld devices.

The systems and method of the invention include a database of questions and a database of suggestions. The question database includes numerous questions that ask users about their interest in participating in a particular activity. The question database may include information which can be used to categorize the activity. For example, the activity may be categorized by type, such as role playing, toys, and types of sexual positions, which may be further categorized. They may also be categorized by intensity level or degree of risqueness. Activities may also be categorized as being appropriate for all individuals or inappropriate for individuals with certain physical conditions, and these conditions may be further categorized. Be categorizing the questions, certain questions or types of questions may be selected or avoided, depending on the users personal information and their expressed preferences, as described further below.

The database of suggestions includes suggestions for activities which correlate to each of the questions in the database of questions. The suggestions may be the same as, related to, or similar to, each question. When users indicate an interest in a particular activity presented in a question, the corresponding suggestion may be selected from the database. The suggestion may include more detailed information about the activity than was presented in the question. In some cases, more than one suggestion may correlate to a question, where each of the suggestions are related and are variations on the activity presented in the question.

By using a website, the user can answer questions regarding sexual topics without the embarrassment of a face-to-face conversation. This encourages more honest responses by the users. Also, because the website, personal computer or portable heldheld device can be accessed at any time, the user can decide when he or she wants to use the invention. Furthermore, because sexual ideas are first raised by the software and not the individual, it can make further discussion or experimentation easier and less embarrassing because the activities were suggested by the software and not by the individual user.

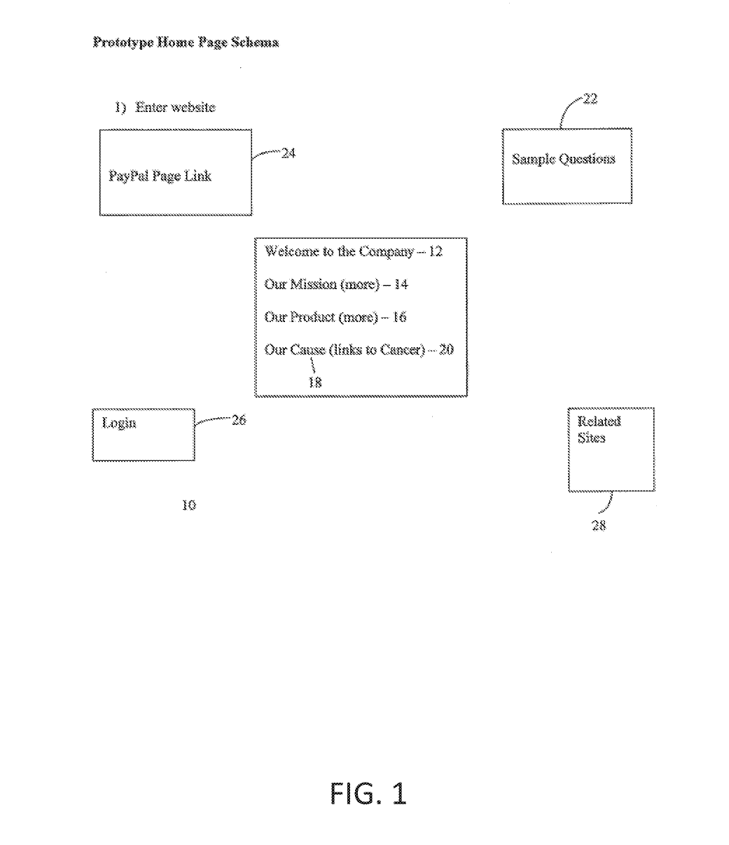

An example of a website homepage according to embodiments of the invention is shown in FIG. 1. The homepage 10 may be visible to the public. The homepage may include a welcome message 12, a mission statement 14, and a description of the website service 16. It may also contain information about a cause 18 and/or a link to information about a cause 20 which may be supported by the proceeds of the services, such as cancer research. The home page 10 may also contain sample questions 22 or a link to sample questions to help the user understand the service. The homepage 10 may also include an enrollment link 24 which directs the user to a payment collection service. The homepage 10 may include a login request 26 or a link to a login request to allow access to secure areas of the website after a user enrolls in the service, such as by making payment. In addition, the homepage may include links to related web sites 28 such as websites for sex therapists, websites selling sex toys, lingerie or other items or medical sites such as The Mayo Clinic's website.

While the home page may be viewed by the public, the website also includes secure areas which are only accessible by a user after inputting login information, which may be a unique username or identification number and/or a password. After logging into the secure areas of the website, the user may access the more sensitive portions of the website, such as user information, user specific questions or surveys, and user specific suggestions.

The user may obtain the login information by enrolling in a service provided by the website. For example, payment may be made using a credit card through a payment service such as PayPal. The enrollment link 24 may include a disclaimer and a terms of services agreement. It may include an explanation of the subscription or subscription options. For example, a subscription may be available which provides weekly questions and suggestions for a certain fee per month, which is automatically billed to a user's credit card each month until a user chooses to cancel the subscription. After a user enrolls, such as by authorizing one or more credit card payments, the user may receive the login information on the webpage or the login information may be sent to the user's email address.

As a preliminary matter, such as after logging into the website for the first time as a new member, the website may collect background information about a user. Such background information request may include general information such as age, gender, sexual orientation, and the name and email address of the user's sexual partner. The partner may then receive an email with his or her login information. The background information may also include questions about the user's medical history, including questions which may be relevant to sexual activity. For example, it may request information about heart conditions, medications, physical injuries or disabilities, impotence, menopause, prostate surgery, and drug use. While not meant to be a source of medical advice, the selection of questions and suggestions may be modified based on these responses. For example, certain physical injuries may prohibit the use of certain sexual positions and these would not be suggested. Furthermore, certain answers may prompt a recommendation to seek advice from a physician. The system may also request background information about sexual practices. For example, the system might inquire about which sexual activities the couple engages in currently. The system may then eliminate questions which relate to the couple's current practices and instead may select questions which relate to activities which would be new for the couple.

In addition, software may be downloaded directly to personal computer or portable handheld device and used without an active internet connection. For example, the software may be a downloaded directly to portable handheld device as an application sold through the iPhone application store. In which case, the login and web access would be unnecessary because of firewall of self-contained device. Furthermore, partner login would also be obviated because the software would allow partners to toggle between partner 1 and partner 2.

Based on the user's response to the background questions, the software will generate a set of questions for the user. These questions 1 may be of a sexual nature and will address the user's interest in engaging in a particular sexual activity with the user's current partner. For example, the question may ask for the user's interest level in engaging in a particular sexual position. The question may include graphics to demonstrate the position. Questions will cover a variety of topics such as sexual positions, intimacy building exercises, use of sexual toys, role playing, fetishes, watching sexually explicit or pornographic movies, and other similar topics. In some embodiments, the questions may also include activities which relate to the relationship but are not sexual in nature. For example, the questions may cover topics such as types of dates, non-sexual activities, gifts and vacations.

The users provide answers to the set of questions to indicate their interest level in the activity. Users may log onto the website independently from their partners to answer the questions or privately toggle to their questions using a personal computer or portable handheld device. In this way, the partners' answers can be kept private from each other, making them more willing to answer freely and honestly and without embarrassment.

The answers that the users provide indicate the users' level of interest in a particular activity. For example, there may be three options for answers such as “definitely interested,” “open to discussion” or “not interested.” Alternatively, the user may rank an activity on a scale ranging from not interested at all to very interested. The scale could be from 1 to 5 or from 1 to 10, for example.

Once both members of a couple submit their responses, the system then compares the responses of each member to identify which activities may be of interest to both users. For example, when a scale of three responses is used, if both users indicate “definitely interested,” then the system identifies this activity as being of interest and may include it as a suggestion. If both users indicate “not interested,” then the system will not include the activity as a suggestion.

For some activities, only one partner will indicate “definitely interested.” In such cases, the system may automatically include or exclude the activity, or it may determine whether to include or exclude the activity based upon the number of matches. For example, if one user indicates “definitely interested” and the user's partner indicates “open to discussion” then the system could automatically identify this activity as an item of interest to both users and include it as a suggestion. Alternatively, the system could decide whether to include or exclude this activity based upon the total number of activities for which both users indicated “definitely interested.” If there are few activities where both partners indicated “definitely interested,” the system could include additional activities where one user indicated “definitely interested” and the other indicated “open to discussion” as suggestions, and the email may include a link to the website.

Similarly, when an interest scale is used, such as a numerical scale, the system may automatically suggest an activity if both members ranked the activity at or above a certain threshold or minimum level or interest, such as 4 out of 5 or 7 out of 10. However, if only one member ranked an activity as having high interest, the system may determine whether or not to include the activity as a suggestion based on the total number of activities about which a high level of interest was indicated. For example, the system may suggest a certain total number of activities by first including those where the couple indicated the highest level of interest and then including activities where the couple indicated a lower level of interest only if necessary. This may be done by using the interest level values to determine threshold or minimum values.

In some embodiments, if one user indicates “interested” or “open to discussion,” and the other user indicates “not interested,” the system determines that this is not an activity of interest and does not suggest the activity. Likewise, if one member indicates a numerical interest level at or below a certain minimum or threshold value, the activity will not be included and the system will not suggest the activity, even if the other member indicated an interest in the activity. Because the response of the more interested user is not revealed to the user's partner, the user can feel free to answer the questions honestly without worrying about the partner's reaction. This is because, if the user's partner does not indicate an interest in the activity, the system will not suggest the activity and the user's partner will not know that the user expressed an interest in the activity.

After the comparison of the answers is complete, the system generates suggestions based upon the users' responses to the questions. The users may receive a set of suggestions via email, may access them by logging into the website, or accessing through software tab on personal computer or portable handheld device, for example. In one embodiment, the system sends the users an email notifying the user that the suggestions are now available on the website.

The suggestions include possible sexual activities which relate to or are similar to or the same as the activities about which the couple indicated an interest when they answered the questions. The suggestions may include, for example, specific sexual positions, toys, or role playing. The suggestions may also include helpful information about the suggested activity. For example, if the suggestion is a sexual position, it may include graphics to help the user understand the position. Alternatively, if the suggestion is a sexual toy, the suggestion may include advertisements or links to websites that sell the toy.

In some embodiments, the suggestions will include information about the couple's responses to the questions. For example, the suggestion may state that both members of the couple indicated that they were interested in an activity. When one member indicated a higher level of interest than the other member, the suggestion may state that both members indicated at least the interest level of the less interested member. For example, if one user indicated “definitely interested” and the user's partner only indicates “may be interested,” the suggestion may state that both members indicated “may be interested.” Similarly, if one member ranked an activity as 10 out of 10, but the other member ranked it as 5 out of 10, then the suggestion would state that both partners ranked the activity at least 5 out of 10. In this way, a user who indicates a higher level of interest does not have to be concerned about the partner's reaction to that interest level, because the actual interest level is not revealed. By stating that both members indicated “at least” the lower interest level, then only an interest level about which both members are comfortable is revealed, so the users can feel free to honestly answer the questions.

After viewing the suggestion lists, the couple can decide whether to engage in the suggested activity. In this way, the couple may feel more free to discuss a new activity or to experiment with new activity, since they now know that both of them have expressed some interest in the activity and will not be shocked by the suggestion. Furthermore, the couple may feel reassured by receiving the suggestion from the system, rather than generating or suggesting the idea themselves, making them feel that the activity is not unusual or abnormal. In addition, the suggestions may include things which the couple had not previously considered, therefore adding an element of creativity to their sexual relationship and fostering new ideas.

In some embodiments, after couples discuss the suggestions in match list, couples may have the option to rerate and prioritize them together according to priority of desirability. Selected suggestions from match lists could be saved in a second database containing approved suggestions from past surveys. The database may be accessed anytime by either user. In addition, there may be a way to activate the random generation of a single suggestion from this approved data base. For example, one user might hit a button or shake the handheld device, which would initiate the production of a single random archived suggestion. This added feature may serve as a fun spontaneous way to explore already agreed upon suggestions. The system therefore provides an entertaining platform for intimacy building by opening up new sexual options to a couple.

The system may periodically provide new sets questions and new suggestions. The users may receive an email, text message, or notification icon on computing device home screen notifying them that there is a new set of questions available, and the message may include a link to the website. A new set of questions may be available 1 week, 2 weeks or 1 month after the couple completed the most recent set of questions or after they viewed the most recent set of suggestions, for example. In some embodiments, the user can select the frequency with which new questions will be available, such as at the time of enrollment or by modifying the user preferences. In some embodiments, a different fee will apply for the service depending on the frequency with which new questions and suggestions are provided to a user. By allowing a period of time between providing a set of suggestions and a new set of questions, the couple has sufficient time to review and discuss the suggestions and to try them, if desired. The subsequent set of questions may include entirely new activities, it may include some activities from second database of approved suggestions, or it may include variations on questions asked in previous surveys. In addition to stock suggestions, users may have the option of creating their own specific questions. This would allow users to pose questions to spouse with the cover of anonymity. Based on the answers to the new set of questions, a new set of suggestions may then be generated from the suggestion bank.

Prior to generating the next set of questions, the system may adapt according to feedback on the previous set of suggestions. In this way, the system may respond to the feedback in generating future questions and suggestions. For example, for each question, the system may inquire whether or not the couple tried the suggestions and whether or not the couple would like more suggestions similar to that suggestion. In this way, the system can determine the couple's interest level in a particular type of activity. If a couple did not try an activity, or if one or both members of the couple indicated they do not wish more similar suggestions, then the system may decrease, eliminate, or temporarily eliminate questions directed to this type of activity. Feedback may be requested at the time that the user enters software to complete the next survey of questions. In this embodiment, the user may be allowed to decline the survey or postpone it until later and proceed directly to the questions, if desired. Alternatively, the system may require the user to provide feedback prior to viewing the next set of questions.

The questions may be adjusted or may evolve depending on the user's responses to previous questions. For example, if a user has indicated a low level or interest or no interest in a particular type of activity, questions about that type of activity may be decreased or eliminated from the user's survey. For example, if a particular question relates to role playing, and a user indicated “not interested” a certain minimum number of times to questions about role playing, such as once or more than once, then other questions relating to role playing could be eliminated from this user's survey. In some embodiments, the questions about that type of activity will be eliminated, but they may be resumed at a later time in case the user's attitude about that type of activity may have changed.

In some embodiments, the system may provide the users with precautions and warnings, such as medical warnings, about certain practices. For example, the system can provide the risk of infection with some practices of orthopedic considerations with trying certain sexual positions.

In some embodiments, the system may keep an anonymous running tally of the responses by all users for each question. The system may then provide this information along with the question, or may make this information available for each question if the user chooses to click on a link. For example, for a particular activity, the system may indicate the percentage of users who indicated “definitely interested,” “open to discussion” and “not interested.” By making these results visible, a user may see that other users are also interested in an activity and may feel less anxious about expressing an interest in that activity and more willing to give an honest answer.

In some embodiments, the system may provide a compatibility rating or compatibility index for a couple based upon their responses. The couple's compatibility may be scored, depending on the number of activities about which both people express an interest. The system could then compare the compatibility score against the compatibility scores of all other couples to determine a compatibility index, which may be provided to the couple. For example, the compatibility index may be a percentile ranking, indicting how the couple's compatibility score compares to other couples using the system.

In some embodiments, the website allows a user to make adjustments or express preferences. For example, a user may be able to indicate whether or not the user would like to receive emails. The user might also be able to indicate a desired level of intensity, intimacy, novelty or kinkiness, about which the user would like to receive questions.

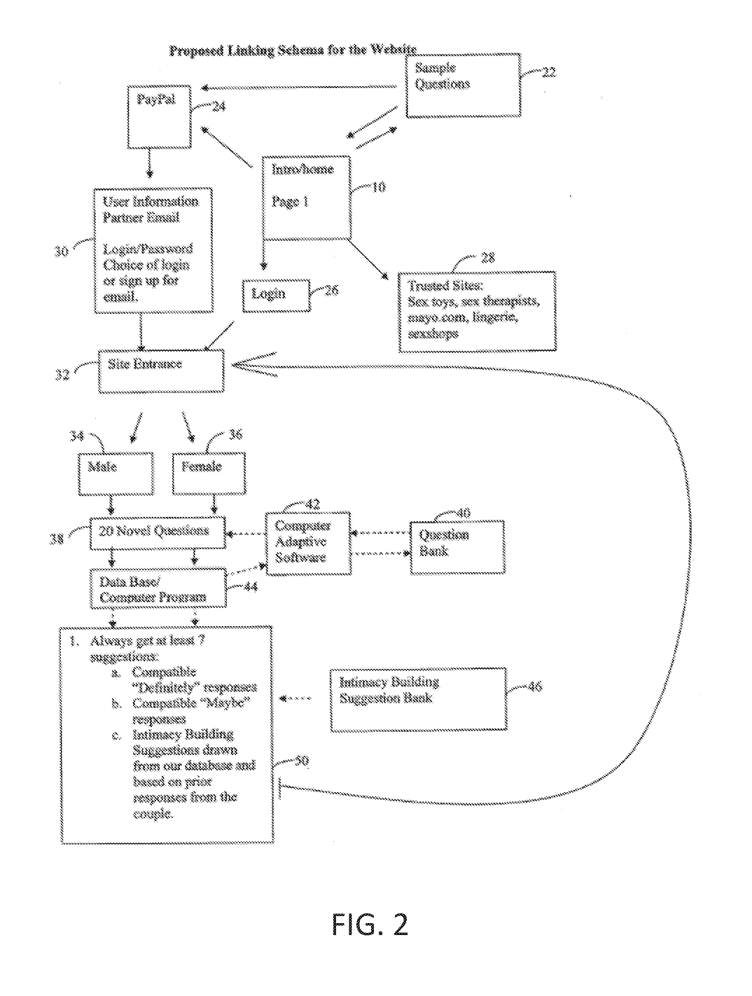

An example of a system and method for providing intimacy building suggestions according to embodiments of the invention is shown in FIG. 2, where the solid arrows indicate a user moving from one webpage to another by clicking on a link. It begins when a user accesses the homepage 10. The information may include a description of the mission of the website and how the service provided by the website works. The home page 10 includes introductory information about the service. From the homepage, the user may choose one of several links. The user may link to sample questions 22, which the reader may read prior to choosing whether to enroll in the service. The user may also link to an enrollment site 24 such as PayPal, to a login 26 for entering the secure areas of the website, or to trusted sites 28 such as sites featuring sex toys, sex therapists, sex shops lingerie or the mayo clinic website. Once the user enters the login information in the login site 26, the user is directed into the secure site entrance 32.

From the enrollment site 24, the user is directed to a login information site 30. This site may collect basic information such as the user's email address and the email address of the user's partner. This site may also allow the user to select a login name and password. Once the user has completed the login information site, the user is directed to the secure site entrance 32. From the site entrance, the user identifies himself or herself as male 34 or female 36, though in other embodiments the system may remember the user's gender and other information from previous sessions or from enrollment and this step may be omitted. The user is then directed to the first set of questions 38. In this example, there are 20 questions. The questions are supplied from a question bank 40 and are processed by computer adaptive software 42. The answers to the questions are stored in a data base/computer program 44, which is also connected to an intimacy building suggestion bank. In this example, at least seven suggestions 50 are supplied from the intimacy building suggestions bank 46. The suggestions 50 include activities about which both users indicated they were “definitely interested” or one user indicated “definitely interested” and the other user indicated “may be interested.” The suggestions 50 are not available for viewing by the users until both members of the couple have completed the questions. Once both members of the couple have completed the questions and the computer program has analyzed the responses and generated suggestions 50, the suggestions 50 are available for them to read. The suggestions 50 may be available on the website or they may be sent by email. An email notification may be sent to the users to notify them that the suggestions 50 are available for review.

In various embodiments, similar systems and methods may be applied regarding a series of products. For example, in some embodiments, a pair of users may view a series of commercial products. Each user can review one or more of a list of products presented, for example, via a display of a computer, smartphone, tablet, or the like. Reviewing products can include ranking products, rating each product on a numeric scale (e.g., from 1-10), rating each product on an interest-type spectrum (e.g., ranging from “not interested” to “very interested” or similar, as discussed elsewhere herein), or other known or similar rating schemes. In an exemplary embodiment, a user may rate each product by choosing one from the list of “interested in buying,” “not interested in buying,” or “may be interested in buying,” or a similar list. In some examples, the viewing and rating of products can be performed on a computer via, for instance, a website, a local software program, or the like. A user may be presented one or more items on a display, and rate one or more of the one or more presented products via a user interface.

In some examples, a first user of the pair of users rates one or more items in a list comprising one or more products. Subsequently, a second user of the pair of users rates one or more like items rated by the first user. In other examples, the first and second users rate like items from a list of items simultaneously, such as via different computers or other devices (e.g., a smartphone, tablet, and the like). For instance, the first and second users may elect to simultaneously and separately rate the items. In general, ratings by users can be entered at any time, however, preferably, the product ratings from each user is kept confidential from the other. For instance, users entering ratings on separate devices are not informed of the ratings entered by another person. In embodiments in which users enter ratings on the same device (e.g., into software running locally on a device), the first user's ratings are stored and hidden from the second user as he or she enters his or her ratings.

The ratings for each commercial product indicated by each user are stored in a memory. In embodiments in which users enter ratings on different devices, ratings submitted by each user may be stored online, such as on a server or in the cloud. Additionally or alternatively, in some embodiments, even if users enter rating information into separate devices, a first user's rating information may be communicated to the second user's device, e.g., via the internet, and vice versa. For example, first and second users using a smartphone running an application (an “app”) enter rating information into the app interface. Ratings entered by the first user may be communicated to the second user's device and stored locally (e.g., by the app) without being visible to the second user. The second user's ratings may be similarly communicated to the first user's device.

In either of such storage examples (e.g., online storage or local storage on both user's devices), each user's rating information is stored in a location accessible by both users' devices. Similarly, in embodiments in which users enter rating information into a single device (e.g., a computer, tablet, smartphone, etc.), such information can be stored such that both users' rating information is accessible by the single device. For example, the rating information may be stored locally on the single device, online (e.g., the cloud), or both.

Each user's rating information for like products can be compared to one another. That is, for each product rated by both users, the ratings of that product by each user can be compared. Comparison information based on the compared ratings can be presented in a variety of formats. In some instances, the comparison information is presented in the form of a display for both users to read together.

In some embodiments, comparison information presented to the users comprises products that were rated similarly by the users, or products for which the rating from each user meets a certain condition. For example, in a numerical rating system in which each user rates a product on a scale of 1-10, with 10 indicating the high rating and 1 indicating the lowest rating, only products rated 7 or higher by both users will be presented to the users. It will be appreciated that these numbers are arbitrary, and numerical rating scales can range across any values. Similarly, in some embodiments incorporating a rating indicating a level of interest including rating options of “interested,” “may be,” or “not interested”, only products rated at least a certain level of interest by both users will be presented to the users. For example, in some embodiments, only products for which both users entered “interested” are displayed. In other embodiments, products for which both users entered either “interested” or “may be” are displayed.

The display may be presented in a variety of ways. For example, in some embodiments, the display including products meeting the user rating requirement is presented as a webpage. The webpage can be interactive, and include links to provide more information about products or for purchasing such products. Additionally or alternatively, an electronic list of products can be generated and emailed to the users. Generated and emailed lists can include one or more of active links to websites for purchasing or finding information about products, images of products, and plain text describing products and/or locations for purchasing products.

In some examples, various aspects of the system can be customizable by a user. For instance, in some embodiments, users may select a rating system to be used (e.g., numerical, interest level, etc.). Additionally or alternatively, in some embodiments, users can set the rating threshold that dictates which products are presented to the users after user rating data has been acquired and compared. For example, in some such embodiments, users can select a numerical rating (e.g., between 1 and 10) for which products rated at or above that rating by both users are presented to the users.

After entering rating information and the comparison of the rating information between the users, users can be presented with a list of products that each user has at least a certain degree of interest in purchasing. In some embodiments, products that meet the rating requirements and are presented to the users may be presented in the form of a link to a website or websites that sell that or similar products. Displayed information may include other information regarding the product, such as a price or customer reviews of the product. In such embodiments, the users are presented with additional information to assist in purchasing desired products.

In some examples, ratings entered by users are stored in a database from which rating information may be analyzed. For example, the database may be used to determine information regarding the number of users that gave a certain rating to a product. For example, information may be used to determine the number and/or percentage of users who rated a product a certain way (e.g., “interested in buying”). In examples in which rating information is tallied, a user can compare his or her ratings to the ratings of other users. In some embodiments, the tallied rating information can be broken down into various categories, such as by gender. In such an example, a female user may compare her ratings to ratings provided by other women. Similarly, a male user may compare his ratings to ratings provided by other men.

In some examples, a user need not provide his or her own rating information to view the tallied rating information. Thus, a user may simply observe product interest rating information. Such information may be useful to a user who is unfamiliar with or hesitant to try such a product. Additionally, such interest rating information may also be valuable to users or companies involved with the production and/or sale of like products.

In some embodiments, software can provide a tally on the compatibility of user pairs. That is, rating information from users who enter rating information in pairs can be analyzed to determine the degree to which the users' ratings are similar. Such information can be used to determine a compatibility score for the pair of users. In some examples, the compatibility score comprises the percentage of products for which each user in a pair of users rated the product similarly. User pairs may then compare their own compatibility score with the compatibility score of other user pairs. In some examples, compatibility scores are associated with certain products. In some such examples, the compatibility score of a product may include a percentage of the number of user pairs in which each user rates that product similarly.

In general, product rating systems as described herein can be used for any product. In various embodiments in which user pairs provide ratings on like products, such products may be within a particular product space. In some such examples, products comprise sex products in a sexual product space. In such examples, user pairs can include a couple in a relationship. Because each user rates product interest levels separately from the other, users can express their interest level in products without fear of embarrassment from their partners. Rather, only those products for which each user displays sufficient interest will be reported to the user pair. This may facilitate a more comfortable discussion or experience for the users, since each user knows his or her partner is mutually interested in a product. Additionally or alternatively, users or user pairs may wish to determine which products for which other user pairs often express mutual interest. User pairs may wish to determine their compatibility regarding certain sex products without feeling pressure or embarrassment.

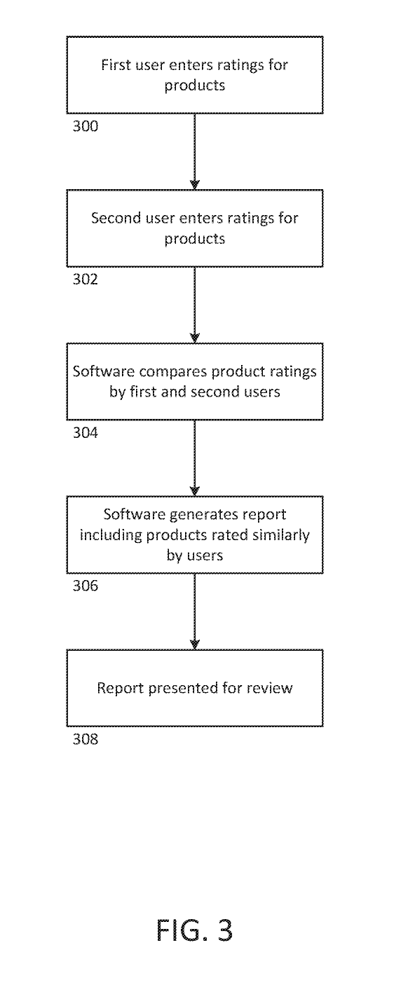

FIG. 3 is a process-flow diagram illustrating use of an exemplary system. In the exemplary method, a first user enters ratings for one or more products (300), for example, on a computer. Next, a second user enters ratings the products (302), for example, on the same computer as the first user. Once the first and second users have each entered his or her ratings, the software (e.g., one or more processors operating according to a software program running locally on the computer or internet-based software running on a server) compares product ratings by the first and second users (304). The software can subsequently generate a report including products that are rated similarly by the first and second users (306). As described elsewhere herein, in some examples, the report can include products that are rated at or above a predetermined interest level by both users. The software can then present the report to the users for review (308).

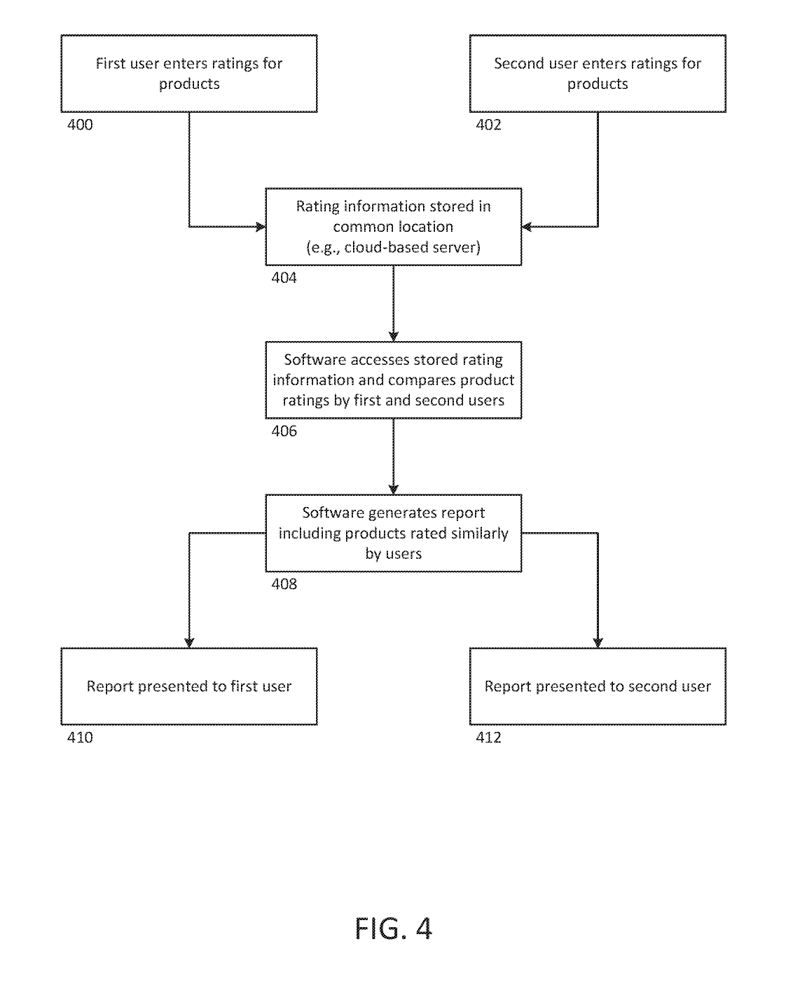

FIG. 4 is a process-flow diagram illustrating alternative user of an exemplary system. In the illustrated method of FIG. 4, a first user enters ratings for products (400) and a second user similarly enters ratings for products (402). However, in the illustrated embodiment, the users may enter ratings simultaneously, for example, from different devices (e.g., different computers or other personal devices such as smartphones, tablets, etc.). The rating information is stored in a common location (404), such as on a cloud-based server. Software accesses stored rating information from the first and second users and compare the product ratings (406). The software can generate a report including products rated similarly by users (408). In some embodiments, software can be online software capable of accessing stored data. Alternatively, software can be installed and running locally on the first and second users' devices, such as in the form of a smartphone app. As described above, the report can include products rated at or above a predetermined interest level by both users, for example. The report can be presented to the first user (410), for example, on the first user's personal device. Similarly, the report can be presented to the second user (412), for example, on the second user's personal device. Thus, the process can be performed without the users sharing a common rating-entry device.

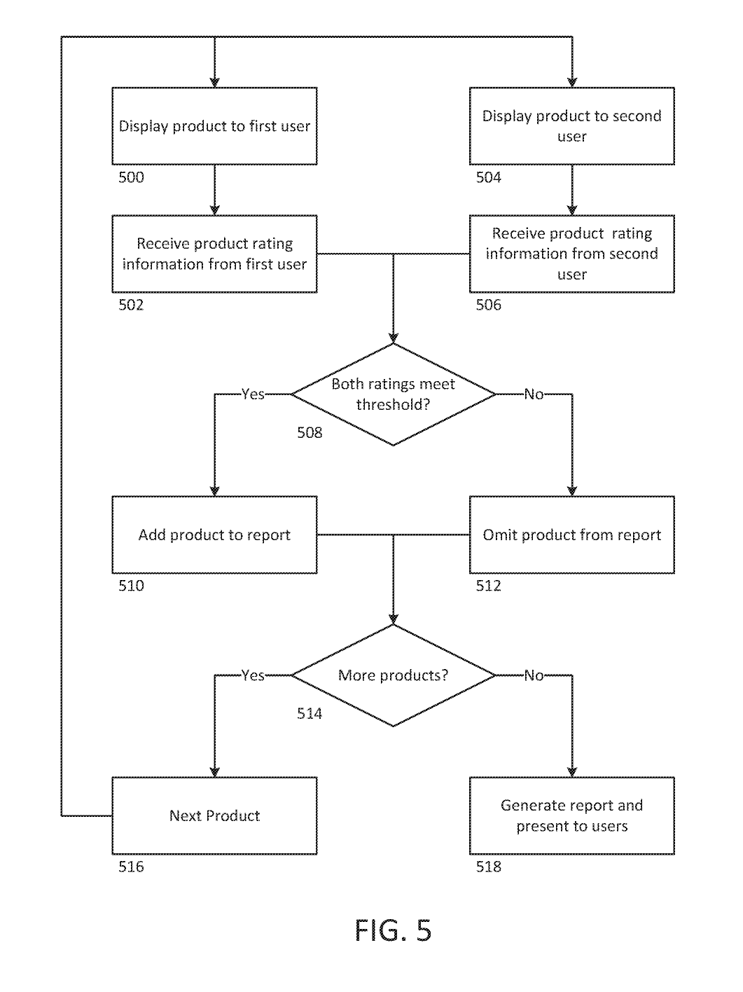

FIG. 5 is an exemplary process-flow diagram showing operation of software according to some implementations. In the illustrated embodiment, a product is displayed to a first user (500) and product rating information regarding the product is received (502). Similarly, the product can be displayed to a second user (504) and product rating information is received from the second user (506). The software can determine if both ratings (from the first and second users) meet a predetermined threshold (508). If so, then the product is added to a report (510). However, if not, the product is omitted from the report (512).

After determining whether or not to include the product in the report, the software can determine whether or not more products are available for rating (514). If more products are available, the process is repeated in which a next product (516) is displayed to a first user (500) and a second user (504) and product rating information from each user is received (502 and 506). If no more products are available for review, the software can generate the report including the items added to the report (e.g., in step 510) and present the report to the user (518).

Various examples and methods have been described. It will be appreciated that these are exemplary and do not limit the scope of the disclosure. In some illustrated and described examples, various steps may be omitted or permuted without departing from the scope of the disclosure. For example, in some instances, software may aggregate rating information from the first user and second user for all available products (e.g., until 514 results in a “no”) prior to performing any rating comparisons (e.g., step 508).

1. A computer-implemented shopping method comprising:
present one or more products for sale to a first user via a first interface; and
receive, from the first user via the first interface, a rating corresponding to the first user's level of interest in each of the presented products;
present the one or more products for sale to a second user; and
receive, from the second user via the second interface, a rating corresponding to the second user's level of interest in each of the presented products;
generate a report of compatible products for the first and second users; and
present the report to the first and second users; wherein generating the report of compatible products comprises, for each of the one or more products for sale:
(i) determining if the rating corresponding to the product from the first user and the rating corresponding to the product from the second user meet a predetermined condition;
(ii) if the ratings corresponding to the product from both the first and second user meet the predetermined condition, considering the product to be a compatible product; and
(iii) adding the product to the list of compatible products.

2. The computer-implemented shopping method of claim 1, wherein presenting the report to the first and second users comprises presenting the report to the first user via the first interface and presenting the report to the second user via the second interface.

3. The computer-implemented shopping method of claim 2, wherein the first interface and the second interface are the same interface.

4. The computer-implemented shopping method of claim 1, wherein the processor operates on a cloud-based server, and wherein the first and second interfaces comprise internet-connected devices.

5. The computer-implemented shopping method of claim 4, wherein the first and second interfaces are provided via an application (“app”) installed on the internet-connected device.

6. The computer-implemented shopping method of claim 4, wherein presenting the generated report to the users comprises sending the report to the users via email.

7. The computer-implemented shopping method of claim 1, wherein the generated report includes links to one or more websites where the products for sale can be purchased, locations where the products can be purchased, images of the products, customer reviews of the products, and/or textual descriptions of the products.

8. The computer-implemented shopping method of claim 1, wherein the predetermined condition comprises the ratings from both the first user and the second user meeting a minimum level of interest for a given product.

9. The computer-implemented shopping method of claim 1, wherein the ratings by the first and second users are not revealed to the other user.

10. The computer-implemented shopping method of claim 1, further configured to analyze ratings provided by a plurality of users to determine statistical information regarding users' preferences of such products.

11. The computer-implemented shopping method of claim 1, wherein the statistical information is sortable into categories and is accessible by a plurality of users.

12. The computer-implemented shopping method of claim 1, wherein the one or more products presented for sale are sex products in a sexual product space.

13. A method for suggesting intimate products to a pair of users comprising:
presenting one or more intimate products to a first user;
for each of the presented intimate products, receiving, from the first user, a rating corresponding to a level of interest of the first user in the product;
presenting the one or more intimate products to a second user;
for each of the presented intimate products, receiving, from the second user, a rating corresponding to a level of interest of the second user in the product;
generating a list of intimate products for which each user has expressed a minimum level of interest;
presenting the generated list of intimate products to the first user and the second user.

14. The method of claim 13, further comprising:
before presenting the one or more intimate products to the first user or the second user, receiving customized settings from the first user and/or the second user; and wherein
the one or more presented intimate products are based on the received customized settings.

15. The method of claim 13, wherein the ratings corresponding to the first and second users' levels of interest in a product are received from a single interface.

16. The method of claim 13, wherein the ratings corresponding to the first and second users' levels of interest in a product are received via an internet connection.

17. The method of claim 13, further comprising saving the generated list of intimate products for later review.

18. A computer-implemented system for assessing interest in one or more intimate products comprising:
a database comprising a list of intimate products;
processor in communication with the database and configured to:
(a) present an intimate product from the database to a first user on a display;
(b) receive a first rating representative of the first user's interest level in the intimate product;
(c) present the intimate product to a second user on a display;
(d) receive a second rating representative of the second user's interest level in the intimate product;
(e) if the first user and second user each express a minimum level of interest in the intimate product, add the intimate product to a list of recommended intimate products for the first and second users;
repeat steps (a)-(e) for a plurality of intimate products from the database.

19. The computer implemented system of claim 18, wherein the plurality of intimate products is a subset of the list of intimate products in the database, and wherein the products are selected from the list based on user-adjustable settings.

20. The computer implemented system of claim 18, wherein the processor is a web-based processor configured to:
receive ratings from a plurality of interfaces representative of a plurality of user's interest level in an intimate product;
sort the received ratings into a plurality of categories; and
provide access to the categorized rating data.
